(19) United States
(12) Patent Application Publication
(10) Pub. No.: US 2026/0119429 A1
(43) Pub. Date: Apr. 30, 2026

(54) SERVER, TASK EXECUTION METHOD AND DEVICE, AND NONVOLATILE READABLE STORAGE MEDIUM

(71) Applicant: SUZHOU METABRAIN INTELLIGENT TECHNOLOGY CO., LTD., Suzhou, Jiangsu (CN)

(72) Inventors: Linge XIAO, Suzhou, Jiangsu (CN); Yanwei WANG, Suzhou, Jiangsu (CN); Rui HAO, Suzhou, Jiangsu (CN); Qianqian ZHAO, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/470,269

(22) PCT Filed: Nov. 28, 2024
(86) PCT No.: PCT/CN2024/135345

§ 371 Date: Oct. 21, 2025

(30) Foreign Application Priority Data
Feb. 27, 2024 (CN) 202410214089.5

(51) Int. Cl. G06F 13/28; G06F 9/50

(52) U.S. Cl. CPC G06F 13/28; G06F 9/5016; G06F 2213/0026

(57) ABSTRACT

A server, a method for executing a task and apparatus, and a non-transitory readable storage medium is provided. The server includes a processor, a processor memory, and an accelerator connected to the processor. The accelerator includes an accelerator memory. The address spaces of the processor memory and the accelerator memory are addressed uniformly based on a CXL protocol to obtain a unified memory. The processor can acquire original data of a target task, store the original data into the unified memory, write instruction data into a register of the accelerator based on the target task; the accelerator can generate an instruction based on the instruction data written into the register, acquire the original data from the unified memory based on the CXL protocol, execute the instruction based on the original data to complete the target task, and write the task execution result into the unified memory.

### CROSS-REFERENCE TO RELATED APPLICATION

The present application claims priority to Chinese Patent application no. 202410214089.5, to the China National Intellectual Property Administration on 27 Feb. 2024 and entitled “Server, Method for Executing a Task and Apparatus, and Non-transitory Computer Readable Storage Medium”.

### TECHNICAL FIELD

The present application relates to the technical field of computers, and in particular, to a server, a method for executing a task and apparatus, and a non-transitory readable storage medium.

### BACKGROUND

At present, mainstream calculation methods can be divided into centralized data centers and distributed edge computing. Since an application program in an edge computing scenario is initiated at an edge side, a service response can be obtained more quickly, meeting the basic needs of consumers in real-time operations, application intelligence, security, privacy protection, etc. As tasks executed by a consumer end in edge computing become burdensome and diversified, some local accelerators are used in an edge computing server to implement acceleration of executing tasks. During the task execution process, data undergoes multiple copy operations between the processor memory and the accelerator memory, resulting in latency and high power consumption of task execution.

Therefore, there is a technical problem in the related technology where task execution experiences latency and high power consumption.

### SUMMARY

The objective of the present application is to provide a server, a method for executing a task and apparatus, and a non-transitory readable storage medium, so as to reduce the latency and power consumption of task execution.

In order to achieve the described object, the present application provides a server, comprising a processor, a processor memory, and an accelerator connected to the processor, wherein the accelerator includes an accelerator memory, and the processor memory and the accelerator memory are addressed uniformly based on a Compute Express Link (CXL) protocol to obtain a unified memory;
the processor is configured to acquire original data of a target task, store the original data into the unified memory, write instruction data into a register of the accelerator based on the target task, and acquire a task execution result of the target task from the unified memory;
the accelerator is configured to generate an instruction based on the instruction data written into the register, acquire the original data from the unified memory based on the CXL protocol, execute the instruction based on the original data to complete the target task, and write the task execution result into the unified memory based on the CXL protocol.
wherein the accelerator includes a CXL core, an instruction generation module and an accelerator core;
the CXL core is configured to communicate with the processor; and
the instruction generation module is configured to generate the instruction based on the instruction data written into the register, and send the instruction to the accelerator core;
the accelerator core is configured to acquire the original data from the unified memory based on the CXL protocol, execute the instruction based on the original data to complete the target task, and write the task execution result into the unified memory based on the CXL protocol.
wherein the CXL core includes a first interface and a second interface, the processor is configured to write data into a register of the accelerator through the first interface; and the accelerator is configured to access the unified memory through the second interface.
wherein the instruction generation module includes a register file submodule, state machines corresponding to instructions of different instruction types, and an instruction processing submodule;
the register file submodule includes instruction data registers corresponding to the different state machines, and the instruction data registers are configured to store instruction data corresponding to the different instruction types;
each of the state machines is configured to generate an instruction of a corresponding instruction type based on instruction data in a corresponding instruction data register, and send the instruction to the instruction processing submodule; and
the instruction processing submodule is configured to process the instruction, and then send the processed instruction to the accelerator core.
wherein the instruction processing submodule is configured to sort, based on startup timestamps of the different state machines, instructions generated by the different state machines to generate a sorting result, and sequentially send the instructions generated by the different state machines to the accelerator core based on the sorting result.
wherein the instruction processing submodule is further configured to reset a target state machine in a case where a difference value between a current timestamp and a startup timestamp of the target state machine is greater than a threshold.
wherein the register file submodule further includes start signal registers and stop signal registers corresponding to the different state machines, each of the start signal registers is configured to indicate whether a corresponding state machine among the different state machines is started, and each of the stop signal registers is configured to indicate whether the instruction data has been written.
wherein in a case where one state machine among the different state machines is in an idle state, the start signal register corresponding to the one state machine is configured to be set to a first preset value; in a case where it is detected that the start signal register corresponding to the one state machine is set to a second preset value by the processor and a timeout reset signal is the first preset value, the one state machine is configured to transition to a waiting information filling state and update a startup timestamp;
in a case where the one state machine is in the waiting information filling state, the one state machine is configured to wait for the processor to fill instruction data into an instruction data register corresponding to the one state machine; and in a case where it is detected that the stop signal register corresponding to the one state machine is set to the second preset value by the processor and the timeout reset signal is not the first preset value, the one state machine is configured to transition to an instruction generation state;
in a case where the one state machine is in the instruction generation state, the one state machine is configured to generate an instruction based on the instruction data in the instruction data register corresponding to the one state machine, and send the generated instruction to the instruction processing submodule, reset the instruction data register corresponding to the one state machine, the start signal register corresponding to the one state machine, and the stop signal register corresponding to the one state machine to the first preset value, and transition to the idle state.
wherein the instructions of different instruction types include a loading instruction, a storage instruction, and an execution instruction, the loading instruction is configured to load data from the unified memory to a cache of the accelerator core, the storage instruction is configured to store data from the cache of the accelerator core to the unified memory, and the execution instruction is configured to execute an operation.
wherein the instruction data includes a physical address of the original data, and the accelerator is configured to acquire the original data from the unified memory based on the physical address.
wherein the accelerator is an accelerator implemented based on a Field Programmable Gate Array (FPGA).
wherein the processor is connected to the accelerator through a Peripheral Component Interconnect Express (PCIe) protocol interface.

In order to achieve the described objective, the present application provides a method for executing a task, applied to a processor in a server, wherein the server includes the processor, a processor memory, and an accelerator connected to the processor; the accelerator includes an accelerator memory; and the processor memory and the accelerator memory are addressed uniformly based on a CXL protocol to obtain a unified memory; the method comprising:
acquiring original data of a target task, and storing the original data in the unified memory;
writing instruction data into a register of the accelerator based on the target task, so that the accelerator generates an instruction based on the instruction data written into the register, acquires the original data from the unified memory based on the CXL protocol, executes the instruction based on the original data to complete the target task, and writes a task execution result into the unified memory based on the CXL protocol; and
acquiring the task execution result from the unified memory.
wherein the instruction data includes a physical address of the original data, and the accelerator is configured to acquire the original data from the unified memory based on the physical address.
wherein the target task includes a neural network inference task.

In order to achieve the described objective, the present application provides a method for executing a task, applied to an accelerator in a server, wherein the server includes a processor, a processor memory, and the accelerator connected to the processor; the accelerator includes an accelerator memory; and the processor memory and the accelerator memory are addressed uniformly based on a CXL protocol to obtain a unified memory; the method includes:
generating an instruction based on instruction data written into a register by the processor;
acquiring original data from the unified memory based on the CXL protocol, and executing the instruction based on the original data to complete a target task; and
writing a task execution result into the unified memory based on the CXL protocol.
wherein the generating an instruction based on instruction data written into a register by the processor includes:
generating instructions by state machines corresponding to instructions of different instruction types, wherein each of the one or more instructions is generated by a corresponding state machine among the state machines based on instruction data in an instruction data register corresponding to the corresponding state machine;
sorting, based on start timestamps of the different state machines, the instructions generated by the different state machines to generate a sorting result, and sequentially send the instructions generated by the different state machines to an accelerator core based on the sorting result;
resetting a target state machine in a case where a difference value between a current timestamp and a start timestamp of the target state machine is greater than a threshold.

In order to achieve the described objective, the present application provides an apparatus for executing a task, applied to a processor in a server, wherein the server includes the processor, a processor memory, and an accelerator connected to the processor; the accelerator includes an accelerator memory; and the processor memory and the accelerator memory are addressed uniformly based on a CXL protocol to obtain a unified memory; the apparatus comprising:
a storage unit, configured to acquire original data of a target task, and store the original data in the unified memory;
a first writing unit, configured to write instruction data into a register of the accelerator based on the target task, so that the accelerator generates an instruction based on the instruction data written into the register, acquires the original data from the unified memory based on the CXL protocol, executes the instruction based on the original data to complete the target task, and writes a task execution result into the unified memory based on the CXL protocol; and
an acquisition unit, configured to acquire the task execution result from the unified memory.

In order to achieve the described objective, the present application provides an apparatus for executing a task, applied to an accelerator in a server, wherein the server includes a processor, a processor memory, and the accelerator connected to the processor; the accelerator includes an accelerator memory; and the processor memory and the accelerator memory are addressed uniformly based on a CXL protocol to obtain a unified memory; the apparatus comprising:
a generation unit, configured to generate an instruction based on the instruction data written into a register by the processor;
an execution unit, configured to acquire original data from the unified memory based on the CXL protocol, and execute the instruction based on the original data to complete a target task; and
a second writing unit, configured to write a task execution result into the unified memory based on the CXL protocol.

To achieve the above objective, the present application provides a non-transitory computer readable storage medium. The non-transitory computer readable storage medium stores a computer program. When the computer program is executed by a processor, the steps of the described method for executing a task are implemented.

It can be determined from the above solutions that the server provided in the present application includes a processor, a processor memory and an accelerator connected to the processor, wherein the accelerator includes an accelerator memory, and the processor memory and the accelerator memory are addressed uniformly based on a Compute Express Link (CXL); the processor is configured to acquire original data of a target task, store the original data into the unified memory, write instruction data into a register of the accelerator based on the target task, and acquire a task execution result of the target task from the unified memory; the accelerator is configured to generate an instruction based on instruction data written into the register, acquire the original data from the unified memory based on the CXL protocol, execute the instruction based on the original data to complete a target task, and write a task execution result into the unified memory based on the CXL protocol.

In the present application, based on a Computing Express Link (CXL), a processor memory and an accelerator memory are addressed uniformly, so that a processor and an accelerator directly access a unified addressed memory space (unified memory), thereby reducing the number of data copy operations between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts. Further disclosed are an apparatus for executing a task, an electronic device and a computer non-transitory readable storage medium, which can also achieve the described technical effect.

It should be understood that both the foregoing general description and the following detailed description are exemplary only and are not intended to limit the application.

### BRIEF DESCRIPTION OF THE DRAWINGS

To describe the technical solutions in the embodiments of the present application or in related technologies more clearly, the following briefly describes the accompanying drawings required for describing the embodiments or related technologies. Apparently, the accompanying drawings in the following description show merely some embodiments of the present application, and a person of ordinary skill in the art may still derive other accompanying drawings from these accompanying drawings without creative efforts. The accompanying drawings are used for providing a further understanding of the present disclosure, constitute a part of the description, and are used for interpreting the present disclosure together with the following specific embodiments, rather than limiting the present disclosure. In the drawings:

FIG. 1 is a structural diagram of a server based on GPU acceleration;

FIG. 2 is a structural diagram of a server according to an exemplary embodiment;

FIG. 3 is a block diagram of an accelerator according to an exemplary embodiment;

FIG. 4 is a block diagram of an instruction generation module according to an exemplary embodiment;

FIG. 5 is a structural diagram of an accelerator core according to an exemplary embodiment;

FIG. 6 is a flowchart of a method for executing a task according to an exemplary embodiment;

FIG. 7 is a flowchart of another method for executing a task according to an exemplary embodiment;

FIG. 8 is a block diagram of an apparatus for executing a task according to an exemplary embodiment;

FIG. 9 is a structural diagram of an apparatus for executing a task according to an exemplary embodiment.

### DETAILED DESCRIPTION OF THE EMBODIMENTS

The technical solutions in the embodiments of the present disclosure will be clearly and completely described below with reference to the accompanying drawings in the embodiments of the present disclosure. It is apparent that the embodiments described are not all embodiments but a part of embodiments of the present disclosure. All other embodiments obtained by a person of ordinary skill in the art based on the embodiments of the present application without any inventive effort shall all fall within the scope of protection of some embodiments of the present application. In addition, in the embodiments of the present application, that terms “first”, “second” and the like are used for distinguishing similar objects rather than describing a specific sequence or a precdence order.

In the related art, tasks executed by an edge computing server are accelerated by a Graphics Processing Unit (GPU); and the Central Processing Unit (CPU) is connected to a high-speed Remote Direct Memory Access (RDMA) network card, a processor memory and the GPU by means of a Peripheral Component Interconnect Express (PCIe) bus.

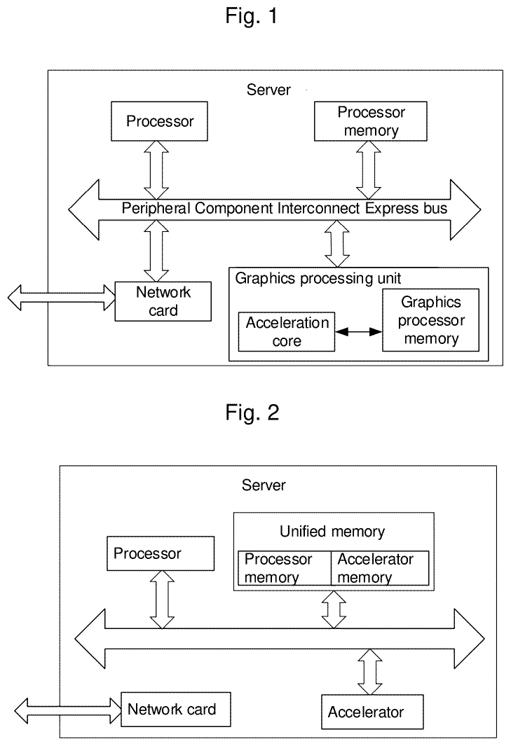

A server based on GPU acceleration is as shown in FIG. 1; a CPU receives, by means of a high-speed RDMA network card, original data required for executing a task and places same into a processor memory; a GPU reads the original data from a processor memory by means of a Host-to-Device (H2D) and places same into a GPU memory; the GPU acceleration core reads the original data from the GPU memory for calculation; the CPU reads result data from the GPU memory by means of a Device-to-Host (D2H) and writes same into the processor memory, reads result data from the memory of the processor by means of the high-speed RDMA network card, and sends same to the consumer end.

The processor memory and the GPU memory are both off-chip Dynamic Random Access Memories (DRAM). In the described solution, there are multiple times of data copying between a processor memory and a GPU memory, that is, there are multiple times of data copying between off-chip DRAMs, resulting in latency and high power consumption of task execution.

Therefore, in the present application, based on a Computing Express Link (CXL), a processor memory and an accelerator memory are addressed uniformly, so that a processor and an accelerator directly access a unified addressed memory space, thereby reducing the number times of data copying between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts.

Disclosed in an embodiment of the present application is a server. As shown in FIG. 2, the server includes a processor, a processor memory, and an accelerator connected to the processor,
wherein the accelerator includes an accelerator memory, and the processor memory and the accelerator memory are addressed uniformly based on a Compute Express Link (CXL) protocol;
the processor is configured to acquire original data of a target task, store the original data into the unified memory, write instruction data into a register of the accelerator based on the target task, and acquire a task execution result of the target task from the unified memory;
the accelerator is configured to generate an instruction based on instruction data written into the register, acquire the original data from the unified memory based on the CXL protocol, execute the instruction based on the original data to complete a target task, and write a task execution result into the unified memory based on the CXL protocol.

The server in the present embodiment may be an edge computing server, and includes a processor and an accelerator. The processor may be connected to the accelerator through a Peripheral Component Interconnect Express (PCIe) protocol interface. The accelerator may be an accelerator implemented based on a Field Programmable Gate Array (FPGA). The server includes a processor memory; the accelerator includes an accelerator memory; and the processor memory and the accelerator memory are addressed uniformly based on a Compute Express Link (CXL) protocol. The CXL protocol is a new interconnect protocol oriented to the CPU and various types of dedicated accelerators, so as to implement effective and stable memory access between a host and a device, and support cache consistency.

The CXL defines three sub-protocols, which are respectively a CXL.io protocol, a CXL.cache protocol, and a CXL.mem protocol. Different devices support different sub-protocols, for example, a Type 1 device supports the CXL.io protocol and the CXL.cache protocol; a Type 2 device supports all three sub-protocols; and a Type 3 device supports the CXL.io protocol and the CXL.mem protocol. In the Type 2 device, the two memories are addressed uniformly to form a unified memory. The accelerator in the present embodiment is equivalent to the Type 2 device.

Hence, as the server in the present embodiment implements unified addressing and data consistency, compared with FIG. 1, after data from a network is stored in a unified memory, the data can be used by a processor and an accelerator at the same time, thereby reducing data migration between a processor memory and an accelerator memory.

As a feasible implementation, the accelerator includes a CXL core, an instruction generation module and an accelerator core; the CXL core is configured to communicate with the processor; and the instruction generation module is configured to generate an instruction based on the instruction data written into the register, and send the instruction to the accelerator core; the accelerator is configured to generate an instruction based on the instruction data written into the register, acquire the original data from the unified memory based on the CXL protocol, execute the instruction based on the original data to complete a target task, and write the task execution result into the unified memory based on the CXL protocol.

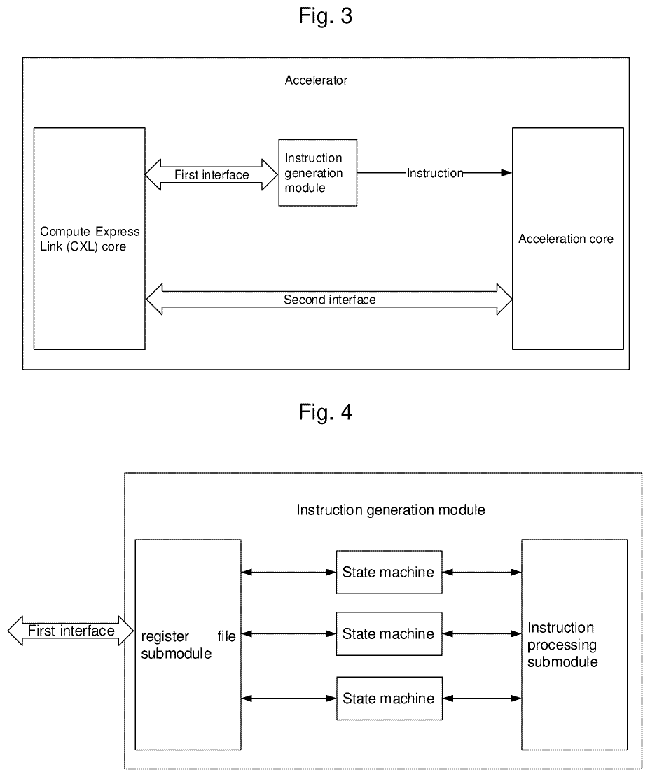

In an optional implementation, a structural diagram of the accelerator is shown in FIG. 3, including a CXL core, an instruction generation module and an accelerator core. The CXL core is a hardware circuit implementation of the CXL, which, in conjunction with a series of software on the host side, achieves functions such as cache coherence and unified memory addressing proposed by CXL. That is, the processor memory and accelerator memory are addressed uniformly at the system level, with the CXL protocol and certain CPU-side software being responsible for ensuring data (cache) consistency of the physically separated but logically unified memories between two computing engines, the processor and the accelerator.

As a feasible implementation, the CXL core includes a first interface and a second interface; the processor is configured to write data into a register of the accelerator through the first interface; and the accelerator is configured to access the unified memory through the second interface.

In an optional implementation, the CXL core is responsible for processing communication with the processor, provides a first interface for the instruction generation module, and is configured to read and write a register in the instruction generation module. In addition, the CXL core provides, to the accelerator core, a second interface that is configured to access the unified memory.

The accelerator core in the present embodiment can be implemented by optimizing and modifying the open-source Gemmini project. The original application architecture includes a Reduced Instruction Set Computer-V (RISC-V) processor system and a Gemmini accelerator, both of which are located on the same chip, thus forming a System on Chip (SoC). The Gemmini accelerator is physically and completely attached to the RISC-V processor, and is configured to control an instruction of the Gemmini accelerator to be a Rocket Chip Coprocessor instruction (RoCC CMD), which is also an instruction format of the RISC-V. However, in the present embodiment, a processor and an accelerator are located on different chips, and the processor and the accelerator are connected by means of a physical bus, for example, a PCIe bus, so as to implement communication between the two chips. The physical bus cannot be compatible with an RoCC CMD, so that the processor cannot control the Gemmini accelerator.

Therefore, in the present embodiment, an instruction generation module is implemented in an accelerator, a processor can access a register in the instruction generation module through a first interface provided by a CXL core; and the instruction generation module can generate, under the control of different internal state machines, corresponding different instructions based on values of the register, and send same to the accelerator core.

As a feasible implementation, the instruction generation module includes a register file submodule, state machines corresponding to instructions of different instruction types, and an instruction processing submodule; The register file submodule includes a plurality of instruction data registers corresponding to different state machines, and are configured to store instruction data corresponding to different instruction types. Each of the state machines is configured to generate an instruction of a corresponding instruction type based on instruction data in a corresponding instruction data register, and send the instruction to the instruction processing submodule. The instruction processing submodule is configured to process the instruction, and then send the processed instruction to the accelerator core.

In an optional implementation, the instruction generation module is as shown in FIG. 4, the processor configures a register file submodule based on the CXL protocol; a register in the register file submodule stores information for generating a RoCC CMD instruction or information for controlling state machines; each register has an independent address; and the processor can access different registers by combining different addresses based on the CXL protocol.

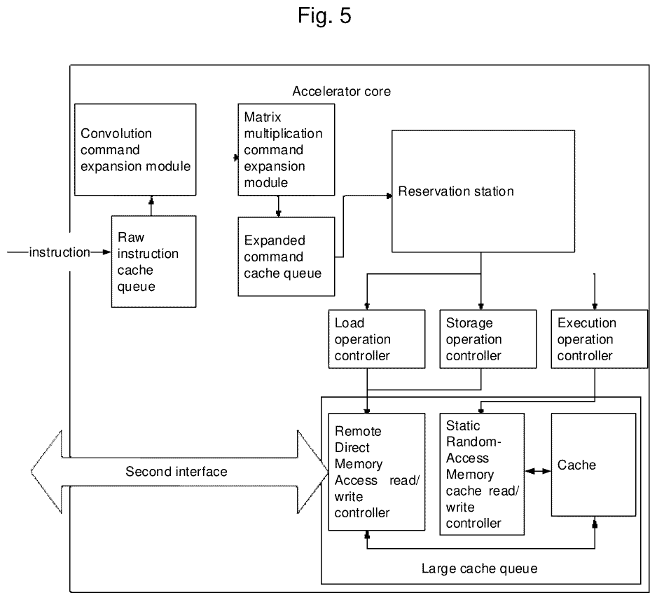

The accelerator core implemented based on Gemmini is as shown in FIG. 5; instructions generated by the instruction generation module are stored in an original instruction cache queue; a convolution instruction expansion module is configured to expand a convolution instruction; a matrix multiplication instruction expansion module is configured to expand a matrix multiplication instruction; and the expanded instruction is stored in the expanded instruction cache queue. Various types of instructions are temporarily stored in a reservation station which is a cache configured to temporarily store transmitted data, since other data may need to be waiting to be ready before performing certain operations. Instructions of different instruction types include a loading instruction, a storage instruction and an execution instruction, i.e. an accelerator core includes a loading operation controller, a storage operation controller and an execution operation controller. The loading instruction is configured to load data from the unified memory to a cache of the accelerator core, the storage instruction is configured to store data from the cache of the accelerator core to the unified memory, and the execution instruction is configured to execute an operation. The accelerator core includes a large cache queue, the large cache queue comprising a DMA read-write controller and a Static Random-Access Memory (SRAM) cache read/write controller, and a cache; the loading operation controller loads data from a unified memory to a cache of an accelerator core by means of the DMA read/write controller; the storage operation controller stores data from the cache of the accelerator core to the unified memory by means of the DMA read/write controller; after executing the operation, the execution operation controller stores the execution result in the cache of the accelerator core by means of the SRAM cache read/write controller.

Different state machines are configured to generate instructions of different types, thereby accelerating the instruction generation efficiency, avoiding mutual interference between instructions of different types, and improving the accuracy of instruction generation. Further, due to differences in the number of registers required for configuration between different types of instructions or instructions of the same type but with different operations, it is possible that the processor first starts configuring registers for generating a certain instruction (e.g., an instruction A), and then begins configuring registers for another instruction (e.g., an instruction B). However, because the instruction A requires configuring more registers than the instruction B, the registers for the instruction B may be configured first, resulting in the instruction B being generated before the instruction A, which is inconsistent with the sequence of operations initiated by the processor.

In order to solve the problem that the order in which the instruction generation module generates instructions is inconsistent with the order in which the processor initiates operations, the instruction processing submodule in the instruction generation module sorts, based on startup timestamps of the different state machines, instructions generated by different state machines, and sequentially sends the instructions generated by the different state machines to the accelerator core based on the sorting result.

In an optional implementation, the instruction processing submodule tracks the startup timestamps of different instruction state machines, i.e. the timestamps when the processor initiates operations. The corresponding instructions are sent to the accelerator core in the order of the startup timestamps when the state machines are started, ensuring that the order in which the accelerator core receives instructions is consistent with an order in which the processor initiates an operation, thereby avoiding an error in the order in which the accelerator core executes the instruction.

Further, the instruction processing submodule is further configured to reset a target state machine in a case where a difference value between a current timestamp and a startup timestamp of the target state machine is greater than a threshold. In an optional implementation, the current timestamp of each state machine is updated in real time. The differences between startup timestamps of state machines of different instructions and the current timestamp are tracked; if the difference exceeds a threshold, the state machine that has not completed its operation for a long time is forcibly reset, so as to correct an error, thereby preventing the state machine from being unavailable for a long time due to an instruction generation failure.

Different state machines each correspond to a plurality of instruction data registers, and the instruction data registers are configured to store instruction data required for generating an instruction. For example, if each state machine corresponds to five instruction data registers, and each instruction data register is 32 bits, then each state machine stores at most 160 bits of instruction data. Each state machine may also have a corresponding start signal register and a corresponding stop signal register. The start signal register is configured to indicate whether the state machine is started, and the stop signal register is configured to indicate whether the instruction data has been written.

As a feasible implementation, in a case where one state machine among the different state machines is in an idle state, the start signal register corresponding to the one state machine is configured to be set to a first preset value; in a case where it is detected that the start signal register corresponding to the one state machine is set to a second preset value by the processor and a timeout reset signal is the first preset value, the one state machine is configured to transition to a waiting information filling state and update a startup timestamp; in a case where the one state machine is in the waiting information filling state, the one state machine is configured to wait for the processor to fill instruction data into an instruction data register corresponding to the one state machine; and in a case where it is detected that the stop signal register corresponding to the one state machine is set to the second preset value by the processor and the timeout reset signal is not the first preset value, the one state machine is configured to transition to an instruction generation state; in a case where the one state machine is in the instruction generation state, the one state machine is configured to generate an instruction based on the instruction data in the instruction data register corresponding to the one state machine, and send the generated instruction to the instruction processing submodule, reset the instruction data register corresponding to the one state machine, the start signal register corresponding to the one state machine, and the stop signal register corresponding to the one state machine to the first preset value, and transition to the idle state.

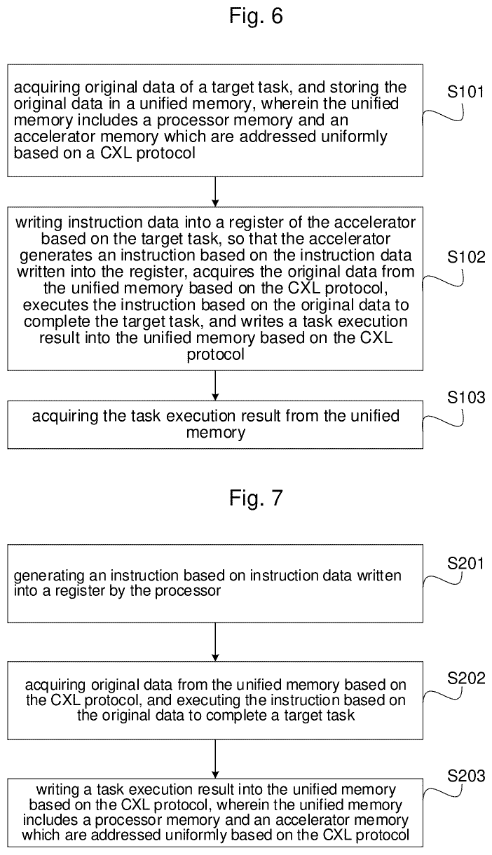

In an optional implementation, the state machine working process of each state machine generating an instruction is shown in FIG. 6, the initial state of the state machine after being powered on is an idle state, and when a start signal register corresponding to the state machine is set to a first preset value (for example, 0), the state machine remains in the idle state. When the state machine detects that the corresponding start signal register is written to the second preset value (for example, 1) and the timeout reset signal is 0, the state machine transitions to a waiting information filling state, and furthermore, the timestamp register of the state machine is updated, indicating the startup timestamp at which the state machine starts working.

After the processor writes the start signal register corresponding to the state machine to a second preset value, the processor continues to operate the instruction data register corresponding to the state machine, and during this period, the state machine remains the waiting information filling state; if the waiting time is too long, it is reset to the idle state by a reset signal from the instruction processing submodule.

After the processor completes the operation on the instruction data register corresponding to the state machine, the processor continues to operate the stop signal state machine corresponding to the state machine, writes the stop signal state machine as the second preset value; and when the state machine detects that the stop signal register is the second preset value and the timeout reset signal is not the first preset value, it transitions to the instruction generation state.

In the instruction generation state, the instruction generation module generates a corresponding instruction using the instruction data, corresponding to the state machine, in the instruction data register, and sends same to the instruction processing module; furthermore, all the registers corresponding to the state machine in the register file submodule and the timestamp register inside the state machine are reset, and in this case, the state machine transitions to an idle state unconditionally.

In addition, since the RISC-V processor system and the Gemini accelerator are located in the same chip in the original application architecture, when the Gemini accesses the L2 cache or the DRAM, the virtual address given by the RPC CMD instruction is used; when the L2 cache or the DRAM is accessed by means of the DMA read-write controller, the virtual address needs to be mapped to a physical address by means of a TLB first, and the physical address is then used for access. The TLB processing module needs to update a correlation between a physical address and a virtual address by means of a RoCC Post-Training Weight (PTW) interface and a CPU, which consumes a long time, and the TLB processing module itself also needs to occupy hardware resources. However, in the present embodiment, the processor and the accelerator are located on different chips, and cannot perform an address mapping operation of the TLB processing module; and computing a data access request received by a CXL core requires using a physical address.

Therefore, in the present embodiment, the processor directly uses the physical address when configuring the register, i.e. the instruction data includes a physical address of the original data, and the accelerator is configured to acquire the original data from the unified memory based on the physical address. In an optional implementation, a processor stores a physical address of data in a register to generate an instruction, and a DMA read/write controller in an accelerator core provides a physical address by means of a second interface to directly connect to a CXL core, so as to access a unified memory, thereby avoiding a conversion between a virtual address and a physical address, and reducing a latency of an accelerator accessing the unified memory.

The procedure for the server provided in the present embodiment to execute a task is as follows: a processor acquires original data of a target task by means of a network, and stores the original data in a processor memory of a unified memory. A processor generates an instruction by means of a CXL interface control instruction generation module; and an operation accelerator directly performs, in a unified memory, a data access operation between a processor memory and an accelerator memory, thereby avoiding an H2D data copying operation between the processor memory and the accelerator memory. The accelerator executes task computing, and stores a task execution result in an accelerator memory of a unified memory. The processor directly sends the task execution result in the unified memory to a client by means of a network, thereby avoiding a D2H data copying operation between the processor memory and the accelerator memory.

In the embodiments of the present application, based on a Computing Express Link (CXL), a processor memory and an accelerator memory are addressed uniformly, so that a processor and an accelerator directly access a unified addressed memory space, thereby reducing the number times of data copying between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts.

Disclosed in an embodiment of the present application is a method for executing a task, which reduces the latency and power consumption of task execution.

Referring to FIG. 6 which is a flowchart of a method for executing a task according to an exemplary embodiment. As shown in FIG. 6, the method includes:

S101: acquiring original data of a target task, and storing the original data in the unified memory, wherein the unified memory includes a processor memory and an accelerator memory which are addressed uniformly based on a CXL protocol.

The method of the present embodiment is performed by a processor in a server. The server includes a processor, a processor memory, and an accelerator connected to the processor, wherein the accelerator includes an accelerator memory, the processor memory and the accelerator memory are addressed uniformly based on a CXL protocol to obtain a unified memory, and the server may be an edge computing server. The objective of the present embodiment is to implement accelerated execution of target tasks by means of the accelerator, and the target tasks may include a neural network inference task. Due to the limitations of computing power, network, and memory resources in edge computing servers, in order to achieve a better execution effect of a task, a neural network inference task, rather than a neural network training task, is generally only run in the edge computation server.

In this step, the processor receives original data of the target task by means of a network, and stores the original data in a processor memory of a unified memory.

S102: writing instruction data into a register of the accelerator based on the target task, so that the accelerator generates an instruction based on the instruction data written into the register, acquires the original data from the unified memory based on the CXL protocol, executes the instruction based on the original data to complete the target task, and writes a task execution result of the target taskinto the unified memory based on the CXL protocol.

In this step, a processor generates an instruction by means of a CXL interface control instruction generation module; and an operation accelerator directly performs, in a unified memory, a data access operation between a processor memory and an accelerator memory, thereby avoiding an H2D data copying operation between the processor memory and the accelerator memory. The accelerator executes task computing, and stores a task execution result in an accelerator memory of a unified memory.

As a feasible implementation, the instruction data includes a physical address of the original data, and the accelerator is configured to acquire the original data from the unified memory based on the physical address.

In an optional implementation, the processor directly uses the physical address when configuring the register, that is, the processor stores a physical address of data in a register to generate an instruction, and a DMA read/write controller in an accelerator core provides a physical address by means of a second interface to directly connect to a CXL core, so as to access a unified memory, thereby avoiding a conversion between a virtual address and a physical address, and reducing a latency of an accelerator accessing the unified memory.

S103: acquiring the task execution result from the unified memory.

In this step, the processor directly sends the task execution result in the unified memory to a client by means of a network, thereby avoiding a D2H data copying operation between the processor memory and the accelerator memory.

In the embodiments of the present application, based on a Computing Express Link (CXL), a processor memory and an accelerator memory are addressed uniformly, so that a processor and an accelerator directly access a unified addressed memory space, thereby reducing the number times of data copying between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts.

Disclosed in an embodiment of the present application is a method for executing a task. In some embodiments:

Referring to FIG. 7 which is a flowchart of another method for executing a task according to an exemplary embodiment. As shown in FIG. 7, the method includes:

S201: generating an instruction based on instruction data written into a register by the processor.

The execution body of the present embodiment is an accelerator in a server, the server comprising a processor, a processor memory, and an accelerator connected to the processor, wherein the accelerator includes an accelerator memory, the processor memory and the accelerator memory are addressed uniformly based on a CXL protocol to obtain a unified memory. The objective of the present embodiment is to implement accelerated execution of target tasks by means of the accelerator.

In an optional implementation, the processor acquires original data of the target task by means of a network, and stores the original data in a processor memory of a unified memory. The processor writes the instruction data into a register of an accelerator by means of a CXL interface; and the instruction generation module of the accelerator generates an instruction based on the instruction data in the register.

As a feasible implementation, generating the instruction based on the instruction data written into the register by the processor includes: generating an instruction of a corresponding instruction type using state machines corresponding to the instructions of different instruction types based on instruction data in a corresponding instruction data register; sorting, based on startup timestamps of the different state machines, instructions generated by different state machines, and sequentially sending the instructions generated by the different state machines to the accelerator core based on the sorting result; resetting a target state machine in a case where a difference value between a current timestamp and a startup timestamp of the target state machine is greater than a threshold.

Different state machines are configured to generate different types of instructions, due to differences in the number of registers required for configuration between different types of instructions or instructions of the same type but with different operations, it is possible that the processor first starts configuring registers for generating a certain instruction (e.g., an instruction A), and then begins configuring registers for another instruction (e.g., an instruction B). However, because the instruction A requires configuring more registers than the instruction B, the registers for the instruction B may be configured first, resulting in the instruction B being generated before the instruction A, which is inconsistent with the sequence of operations initiated by the processor.

In order to solve the problem that the order in which the instruction generation module generates instructions is inconsistent with the order in which the processor initiates operations, the instruction processing submodule in the instruction generation module sorts, based on startup timestamps of the different state machines, instructions generated by different state machines, and sequentially sends the instructions generated by the different state machines to the accelerator core based on the sorting result.

In an optional implementation, the instruction processing submodule tracks the startup timestamps of different instruction state machines, i.e. the timestamps when the processor initiates operations. The corresponding instructions are sent to the accelerator core in the order of the timestamps when the state machines are started, ensuring that the order in which the accelerator core receives instructions is consistent with an order in which the processor initiates an operation.

Further, the current timestamp of each state machine is updated in real time. The differences between timestamps of start moments of state machines of different instructions and the current timestamp are tracked; if the difference exceeds a threshold, the state machine that has not completed its operation for a long time is forcibly reset, so as to correct an error, thereby preventing the state machine from being unavailable for a long time due to an instruction generation failure.

The state machine working process of each state machine generating an instruction includes: the initial state of the state machine after being powered on is an idle state, and when a start signal register corresponding to the state machine is set to a first preset value (for example, 0), the state machine remains in the idle state. When the state machine detects that the corresponding start signal register is written to the second preset value (for example, 1) and the timeout reset signal is 0, the state machine transitions to a waiting information filling state, and furthermore, the timestamp register of the state machine is updated, indicating the startup timestamp at which the state machine starts working.

After the processor writes the start signal register corresponding to the state machine to a second preset value, the processor continues to operate the instruction data register corresponding to the state machine, and during this period, the state machine remains the waiting information filling state; if the waiting time is too long, it is reset to the idle state by a reset signal from the instruction processing submodule.

After the processor completes the operation on the instruction data register corresponding to the state machine, the processor continues to operate the stop signal state machine corresponding to the state machine, writes the stop signal state machine as the second preset value; and when the state machine detects that the stop signal register is the second preset value and the timeout reset signal is not the first preset value, it transitions to the instruction generation state.

In the instruction generation state, the instruction generation module generates a corresponding instruction using the instruction data, corresponding to the state machine, in the instruction data register, and sends same to the instruction processing module; furthermore, all the registers corresponding to the state machine in the register file submodule and the timestamp register inside the state machine are reset, and in this case, the state machine transitions to an idle state unconditionally.

S202: acquiring original data from the unified memory based on the CXL protocol, and executing the instruction based on the original data to complete a target task.

In this step, the accelerator directly performs, in the unified memory, a data access operation between the processor memory and the accelerator memory based on the CXL protocol, thereby avoiding an H2D data copying operation between the processor memory and the accelerator memory. Further, the accelerator performs task computing based on the acquired original data.

S203: writing a task execution result of the target task into the unified memory based on the CXL protocol, wherein the unified memory includes a processor memory and an accelerator memory which are addressed uniformly based on the CXL protocol.

In this step, the accelerator executes task computing, and stores a task execution result in an accelerator memory of a unified memory. The processor directly sends the task execution result in the unified memory to a client by means of a network, thereby avoiding a D2H data copying operation between the processor memory and the accelerator memory.

In the embodiments of the present application, based on a Computing Express Link (CXL), a processor memory and an accelerator memory are addressed uniformly, so that a processor and an accelerator directly access a unified addressed memory space, thereby reducing the number times of data copying between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts.

an apparatus for executing a task provided in an embodiment of the present application is introduced as follows. The apparatus for executing a task described below and the method for executing a task described above may be referenced correspondingly.

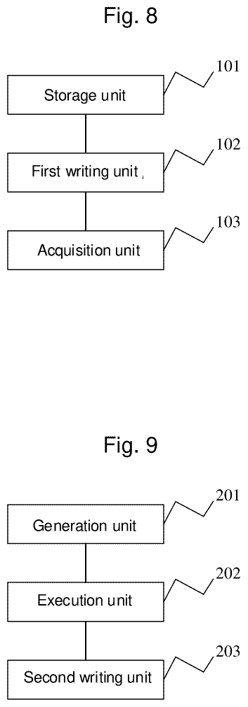

Referring to FIG. 8 which is a structural diagram of an apparatus for executing a task according to an exemplary embodiment, as shown in FIG. 8, the apparatus includes:
a storage unit 101, configured to acquire original data of a target task, and store the original data in the unified memory;
a first writing unit 102, configured to write instruction data into a register of the accelerator based on the target task, so that the accelerator generates an instruction based on the instruction data written into the register, acquires the original data from the unified memory based on the CXL protocol, executes the instruction based on the original data to complete the target task, and writes a task execution result into the unified memory based on the CXL protocol; and
an acquisition unit 103, configured to acquire the task execution result from the unified memory.

In the embodiments of the present application, based on a Computing Express Link (CXL), a processor memory and an accelerator memory are addressed uniformly, so that a processor and an accelerator directly access a unified addressed memory space, thereby reducing the number times of data copying between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts.

On the basis of the described embodiments, as an optional implementation, the instruction data includes a physical address of the original data, and the accelerator is configured to acquire the original data from the unified memory based on the physical address.

On the basis of the foregoing embodiment, as an optional implementation, the target task includes a neural network inference task.

Another apparatus for executing a task provided in an embodiment of the present application is introduced as follows. The apparatus for executing a task described below and the another method for executing a task described above may be referenced correspondingly.

Referring to FIG. 9 which is a structural diagram of another apparatus for executing a task according to an exemplary embodiment, as shown in FIG. 9, the apparatus includes:
a generation unit 201, configured to generate an instruction based on the instruction data written into a register by the processor;
an execution unit 202, configured to acquire original data from the unified memory based on the CXL protocol, and execute the instruction based on the original data to complete a target task; and
a second writing unit 203, configured to write a task execution result into the unified memory based on the CXL protocol.

In the embodiments of the present application, based on a Computing Express Link (CXL), a processor memory and an accelerator memory are addressed uniformly, so that a processor and an accelerator directly access a unified addressed memory space, thereby reducing the number times of data copying between the processor memory and the accelerator memory is reduced, and reducing the latency and energy consumption of task execution. In addition, a processor writes instruction data into a register of an accelerator, and the accelerator generates an instruction based on the instruction data written into the register, thereby implementing conversion between register configuration information of the processor and an accelerator instruction, providing effective control logic of the processor for the accelerator, and implementing independent deployment of the accelerator for CXL-compatible server hosts.

On the basis of the above embodiment, as an optional implementation, the generation unit 201 is configured to: generate an instruction of a corresponding instruction type using state machines corresponding to the instructions of different instruction types based on instruction data in a corresponding instruction data register; sort, based on startup timestamps of the different state machines, instructions generated by different state machines, and sequentially send the instructions generated by the different state machines to the accelerator core based on the sorting result; reset a target state machine in a case where a difference value between a current timestamp and a startup timestamp of the target state machine is greater than a threshold.

With respect to the apparatus in the foregoing embodiments, the manner in which the modules execute the operations has been described in details in the embodiments of the method, and is not described in detail herein.

The embodiments of the present application further provide a non-transitory computer readable storage medium, which can be selected as a computer non-transitory readable storage medium. The non-transitory computer readable storage medium includes, for example, a memory 3 storing a computer program. The computer program can be executed by a processor 2 to complete the foregoing method steps. The computer non-transitory readable storage medium may be a Magnetic Random Access Memory (FRAM), a read-only memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disk, a Compact Disc Read-Only Memory (CD-ROM) and a random access memory (RAM), Random Access Memory, which is used as an external cache. As exemplary rather than restrictive description, many forms of RAM can be used, such as a static random access memory (SRAM), a Synchronous Static Random Access Memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct Rambus random access memory (DRRAM).

A person of ordinary skill in the art would understand that all or some steps of the method embodiment may be completed by programs instructing relevant hardware. The programs may be stored in a non-transitory computer readable storage medium. When the programs are executed, the steps of the described method embodiments can be implemented.

Alternatively, if the integrated unit is implemented in the form of a software functional module and is sold or used as an independent product, the integrated unit can be stored in a non-transitory computer readable storage medium. Based on such understanding, the essence of technical solution of the embodiments of the embodiments of the present application, or in other words, the part of the technical solutions making contributions to the related technologies, may be embodied in the form of a software product stored in a non-transitory readable storage medium, including several instructions for instructing an electronic device (which may be a personal computer, a server, a network device, etc.) to execute all or a part of the methods in the embodiments of the present application.

The foregoing manners are merely optional implementations of the present application, and the scope of protection of the present application is not limited thereto. A person skilled in the art would have readily conceived of variations or replacements within the technical scope disclosed in the present application, and the variations or replacements shall all belong to the scope of protection of the present application.

1. A server, comprising a processor, a processor memory, and an accelerator connected to the processor, wherein the accelerator comprises an accelerator memory, and the processor memory and the accelerator memory are addressed uniformly based on a Compute Express Link (CXL) protocol to obtain a unified memory;
the processor is configured to acquire original data of a target task, store the original data into the unified memory, write instruction data into a register of the accelerator based on the target task, and acquire a task execution result of the target task from the unified memory;
the accelerator is configured to generate an instruction based on the instruction data written into the register, acquire the original data from the unified memory based on the CXL protocol, execute the instruction based on the original data to complete the target task, and write the task execution result into the unified memory based on the CXL protocol;
wherein the accelerator comprises a CXL core, an instruction generation module and an accelerator core;
the CXL core is configured to communicate with the processor; and
the instruction generation module is configured to generate the instruction based on the instruction data written into the register, and send the instruction to the accelerator core;
the accelerator core is configured to acquire the original data from the unified memory based on the CXL protocol, execute the instruction based on the original data to complete the target task, and write the task execution result into the unified memory based on the CXL protocol;
wherein the instruction generation module comprises a register file submodule, state machines corresponding to instructions of different instruction types, and an instruction processing submodule;
the register file submodule comprises instruction data registers corresponding to the different state machines, and the instruction data registers are configured to store instruction data corresponding to the different instruction types;
each of the state machines is configured to generate an instruction of a corresponding instruction type based on instruction data in a corresponding instruction data register, and send the instruction of the corresponding instruction type to the instruction processing submodule; and
the instruction processing submodule is configured to process the instruction of the corresponding instruction type, and then send the processed instruction to the accelerator core.

2. (canceled)

3. The server according to claim 1, wherein the CXL core comprises a first interface and a second interface, the processor is configured to write the instruction data into a register of the accelerator through the first interface; and the accelerator is configured to access the unified memory through the second interface.

4. (canceled)

5. The server according to claim 1, wherein the instruction processing submodule is configured to sort, based on startup timestamps of the different state machines, instructions generated by the different state machines to generate a sorting result, and sequentially send the instructions generated by the different state machines to the accelerator core based on the sorting result.

6. The server according to claim 1, wherein the instruction processing submodule is further configured to reset a target state machine among the state machines in a case where a difference value between a current timestamp and a startup timestamp of the target state machine is greater than a threshold.

7. The server according to claim 1, wherein the register file submodule further comprises start signal registers and stop signal registers corresponding to the different state machines, each of the start signal registers is configured to indicate whether a corresponding state machine among the different state machines is started, and each of the stop signal registers is configured to indicate whether the corresponding instruction data has been written.

8. The server according to claim 7, wherein,
in a case where one state machine among the different state machines is in an idle state, the start signal register corresponding to the one state machine is configured to be set to a first preset value; in a case where it is detected that the start signal register corresponding to the one state machine is set to a second preset value by the processor and a timeout reset signal is the first preset value, the one state machine is configured to transition to a waiting information filling state and update a startup timestamp;
in a case where the one state machine is in the waiting information filling state, the one state machine is configured to wait for the processor to fill corresponding instruction data into an instruction data register corresponding to the one state machine; and in a case where it is detected that the stop signal register corresponding to the one state machine is set to the second preset value by the processor and the timeout reset signal is not the first preset value, the one state machine is configured to transition to an instruction generation state;
in a case where the one state machine is in the instruction generation state, the one state machine is configured to generate an instruction based on the instruction data in the instruction data register corresponding to the one state machine, and send the generated instruction to the instruction processing submodule, reset the instruction data register corresponding to the one state machine, the start signal register corresponding to the one state machine, and the stop signal register corresponding to the one state machine to the first preset value, and transition to the idle state.

9. The server according to claim 1, wherein the instructions of different instruction types comprise a loading instruction, a storage instruction, and an execution instruction, the loading instruction is configured to load data from the unified memory to a cache of the accelerator core, the storage instruction is configured to store data from the cache of the accelerator core to the unified memory, and the execution instruction is configured to execute an operation.

10. The server according to claim 1, wherein the instruction data comprises a physical address of the original data, and the accelerator is configured to acquire the original data from the unified memory based on the physical address.

11. The server according to claim 1, wherein the accelerator is an accelerator implemented based on a Field Programmable Gate Array (FPGA).

12. The server according to claim 1, wherein the processor is connected to the accelerator through a Peripheral Component Interconnect Express (PCIe) protocol interface.

13. A method for executing a task, applied to a processor in a server according to claim 1, wherein the server comprises the processor, a processor memory, and an accelerator connected to the processor; the accelerator comprises an accelerator memory; and the processor memory and the accelerator memory are addressed uniformly based on a CXL protocol to obtain a unified memory; the method comprising:
acquiring original data of a target task, and storing the original data in the unified memory;
writing instruction data into a register of the accelerator based on the target task, so that the accelerator generates an instruction based on the instruction data written into the register, acquires the original data from the unified memory based on the CXL protocol, executes the instruction based on the original data to complete the target task, and writes a task execution result of the target task into the unified memory based on the CXL protocol; and
acquiring the task execution result from the unified memory.

14. The method according to claim 13, wherein the instruction data comprises a physical address of the original data, and the accelerator is configured to acquire the original data from the unified memory based on the physical address.

15. The method according to claim 13, wherein the target task comprises a neural network inference task.

16. A method for executing a task, applied to an accelerator in a server according to claim 1, wherein the server comprises a processor, a processor memory, and the accelerator connected to the processor; the accelerator comprises an accelerator memory; and the processor memory and the accelerator memory are addressed uniformly based on a CXL protocol to obtain a unified memory; the method comprises:
generating an instruction based on instruction data written into a register by the processor;
acquiring original data from the unified memory based on the CXL protocol, and executing the instruction based on the original data to complete a target task; and
writing a task execution result of the target task into the unified memory based on the CXL protocol.

17. The method according to claim 16, wherein the generating an instruction based on instruction data written into a register by the processor comprises:
generating instructions by state machines corresponding to instructions of different instruction types, wherein each of the one or more instructions is generated by a corresponding state machine among the state machines based on instruction data in an instruction data register corresponding to the corresponding state machine;
sorting, based on start timestamps of the different state machines, the instructions generated by the different state machines to generate a sorting result, and sequentially sending the instructions generated by the different state machines to an accelerator core based on the sorting result;
resetting a target state machine among the different state machines in a case where a difference value between a current timestamp and a start timestamp of the target state machine is greater than a threshold.

18. (canceled)

19. (canceled)

20. A non-transitory computer readable storage medium, wherein the non-transitory computer readable storage medium stores a computer program, and when the computer program is executed, steps of the method for executing a task according to claim 13 are implemented.

21. A non-transitory computer readable storage medium, wherein the non-transitory computer readable storage medium stores a computer program, and when the computer program is executed, steps of the method for executing a task according to claim 14 are implemented.

22. A non-transitory computer readable storage medium, wherein the non-transitory computer readable storage medium stores a computer program, and when the computer program is executed, steps of the method for executing a task according to claim 15 are implemented.

23. A non-transitory computer readable storage medium, wherein the non-transitory computer readable storage medium stores a computer program, and when the computer program is executed, steps of the method for executing a task according to claim 16 are implemented.

24. A non-transitory computer readable storage medium, wherein the non-transitory computer readable storage medium stores a computer program, and when the computer program is executed, steps of the method for executing a task according to claim 17 are implemented.
